(19) United States
(12) Patent Application Publication
(10) Pub. No.: US 2018/0120637 A1
(43) Pub. Date: May 3, 2018

(54) BACKLIGHT UNIT, DISPLAY APPARATUS INCLUDING THE SAME AND MANUFACTURING METHOD THEREOF

(71) Applicant: Samsung Display Co., Ltd., Yongin-Si (KR)

(72) Inventors: Haeju YUN, Hwaseong-si (KR); Jungsuk BANG, Seoul (KR); Kwangsoo BAE, Suwon-si (KR); Minjeong OH, Gimpo-si (KR)

(21) Appl. No.: 15/790,141

(22) Filed: Oct. 23, 2017

(30) Foreign Application Priority Data
Oct. 27, 2016 (KR) 10-2016-0141417

(51) Int. Cl. G02F 1/1335; G02F 1/1333; F21V 8/00

(52) U.S. Cl. CPC G02F 1/133602; G02B 6/0025; G02F 1/133345

(57) ABSTRACT

A manufacturing method of a backlight unit includes: providing a light emission surface of a light guide plate to include contact areas and a cavity area between contact areas; forming first sacrifice patterns at the cavity area to have a same width as each other; forming a first insulation layer on the first sacrifice patterns and extended to contact the light emission surface at the contact areas; removing the first sacrifice patterns to form a cavity between the light emission surface and the first insulation layer, at the cavity area; and with the cavity at the cavity area, forming a second insulation layer at the cavity area and at the contact areas. The contact areas are arranged spaced apart from each other in the first direction, and a number of the first sacrifice patterns at the cavity area decreases as a distance in the first direction increases.

This application claims priority to Korean Patent Application No. 10-2016-0141417, filed on Oct. 27, 2016, and all the benefits accruing therefrom under 35 U.S.C. § 119, the contents of which in their entirety are herein incorporated by reference.

### BACKGROUND

### 1. Field

The present disclosure relates to a display apparatus and a method of manufacturing the same, more particularly to a backlight unit of the display apparatus having improved brightness uniformity and reduced overall thickness.

### 2. Description of the Related Art

A display apparatus is classified into a self-emissive display apparatus, such as an organic light emitting diode display (“OLED”), a field emission display (“FED”), a vacuum fluorescent display (“VFD”), a plasma display panel (“PDP”), etc., and a non-self-emissive display apparatus, such as a liquid crystal display (“LCD”), an electrophoretic display, etc.

The non-self-emissive display apparatus includes a backlight unit generating a light used by the display apparatus to display an image.

A display apparatus provides a display panel which generates and displays an image by using light and a backlight unit which generates the light. The backlight unit includes a light source, an optical member and an optical sheet. The light source generates a light, and the optical member transmits the light from the light source to the display panel.

### SUMMARY

One or more embodiment of the present disclosure provides a backlight unit with an overall reduced thickness and improved brightness uniformity.

An embodiment of the disclosure provides a manufacturing method of a backlight unit including: providing a light guide plate including a light emission surface, a light incident surface and a light opposite surface which faces the light incident surface in a first direction, the light emission surface comprising a plurality of contact areas and a cavity area which is between adjacent contact areas; forming a plurality of first sacrifice patterns on the light emission surface of the light guide plate at the cavity area thereof, the plurality of first sacrifice patterns having a same width as each other in the first direction; forming a first insulation layer on the plurality of first sacrifice patterns at the cavity area of the light guide plate, such first insulation layer extended to contact the light emission surface of the light guide plate at the contact areas; removing the plurality of first sacrifice patterns to form a cavity between the light emission surface of the light guide plate and the first insulation layer, at the cavity area; and with the cavity formed at the cavity area, forming a second insulation layer on the first insulation layer at the cavity area and at the contact areas. The contact areas are arranged spaced apart from each other in the first direction, and a number of the first sacrifice patterns at the cavity area between the adjacent contact areas decreases as a distance in the first direction from the light incident surface increases.

In an embodiment, forming the first sacrifice patterns may includes: forming a photoresist on the light emission surface of the light guide plate; forming a plurality of first photoresist patterns having a same width as each other in the first direction, by patterning the photoresist; and heating the first photoresist patterns to respectively form the plurality of first sacrifice patterns having a lateral face at the contact areas, the lateral face to have a target slant angle. The target slant angle is defined as an angle between the lateral face of the first sacrifice patterns at the contact area and the light emission surface of the light guide plate. The target slant angle may be between about 55° and about 65°.

In an embodiment, forming the cavity may include removing a portion of the first insulation layer at the cavity area between the adjacent contact areas, to form a hole at the cavity area which is between the adjacent contact areas; and providing a first etchant to the hole to remove the plurality of first sacrifice patterns at the cavity area and form the cavity

In an embodiment, forming the hole may include: forming a third photoresist pattern on the first insulation layer at the cavity area to expose the portion of the first insulation layer at the cavity area; and removing the third photoresist pattern and the portion of the first insulation layer at the cavity area, by providing a second etchant to the portion of the first insulation layer exposed by the third photoresist pattern.

In an embodiment, a method of manufacturing a backlight unit may further include: with the plurality of first sacrifice patterns at the cavity area between the adjacent contact areas, forming a plurality of second photoresist patterns between lateral faces of the first sacrifice patterns within the cavity area; and heating the second photoresist patterns between the lateral faces of the first sacrifice patterns within the cavity area, to form a plurality of second sacrifice patterns between the lateral faces of the first sacrifice patterns within the cavity area. The forming the first insulation layer may dispose the first insulation layer on an upper surface of the first sacrifice patterns and on an upper surface of the second sacrifice patterns.

In an embodiment, forming the cavity may include: removing a portion of the first insulation layer at the cavity area between the adjacent contact areas, to form a hole at the cavity area between the adjacent contact areas; and providing a first etchant to the hole to remove the plurality of first sacrifice patterns and the plurality of second sacrifice patterns at the cavity area and form the cavity.

Portions of the cavity area alternate with contact areas in the first direction, and within a single portion of the cavity area, bottom surfaces of the first sacrifice patterns are connected to each other. A refractive index of the light guide plate may be greater than that of the cavity, equal to that of the second insulation layer, and lower than or equal to that of the first insulation layer. The refractive index of the cavity may be about 1.0. Each of the contact areas may have a same width.

In an embodiment, a backlight unit includes: a light source which generates a light used by a display member to display an image; a light guide plate including a light emission surface through which the light exits the light guide plate to the display member, a light incident surface through which the light enters the light guide plate from the light source, and a light opposite surface facing the light incident surface in the first direction; and a light condensing member in contact with the light emission surface of the light guide plate to condense the light exiting from the light guide plate. The light emission surface of the light guide plate defines a plurality of contact areas at which the light condensing member contacts the light guide plate, the contact areas arranged spaced apart from each other in the first direction. The light condensing member includes: a first insulation layer contacting the light emission surface of the light guide plate at the contact areas thereof, the first insulation layer spaced apart from the light emission surface of the light guide plate to define a cavity between adjacent contact areas; and a second insulation layer disposed on the first insulation layer at the contact areas of the light guide plate and at the cavity. For the contact areas arranged spaced apart from each other in the first direction, a width between the adjacent contact areas decreases as a distance in the first direction from the light incident surface increases.

In an embodiment, a display apparatus includes: a display panel which displays an image with light; and a back light unit which provides the light to the display panel. The backlight unit includes: a light source which generates the light; and an optical member which guides the light from the light source to the display panel. The optical member includes: a light guide plate including a light emission surface through which the light exits the light guide plate, and a light incident surface at which the light source is disposed; and a light condensing member in contact with the light emission surface of the light guide plate to condense the light exiting from the light guide plate. The light emission surface of the light guide plate defines a plurality of contact areas at which the light condensing member contacts the light guide plate, the contact areas arranged spaced apart from each in a direction away from the light incident surface of the light guide plate. The light condensing member defines a plurality of cavities respectively between contact areas adjacent to each other, and in the direction away from the light incident surface of the light guide plate, an interval between the adjacent contact areas decreases as a distance from the light incident surface increases.

### BRIEF DESCRIPTION OF THE DRAWINGS

The above and other advantages of the present disclosure will become readily apparent by reference to the following detailed description when considered in conjunction with the accompanying drawings wherein:

FIG. 1 is an exploded perspective view showing an exemplary embodiment of a display apparatus according to the invention.

FIG. 2 is an enlarged cross-sectional view of the display apparatus taken along line I-I′ of FIG. 1.

FIG. 3 is an enlarged cross-sectional view showing an exemplary embodiment of a display member of the display apparatus shown in FIG. 1.

FIG. 4 is an exploded perspective view of an exemplary embodiment of an optical member of a display apparatus.

FIG. 5 is an enlarged cross-sectional view of the optical member taken along line II-II′ of FIG. 4.

FIG. 6 is an enlarged cross-sectional view of area A of the optical member of FIG. 5.

FIG. 7 is an enlarged rear view of area B of an exemplary embodiment of a light condensing member shown in FIG. 4.

FIG. 8A is an enlarged cross-sectional view showing another exemplary embodiment of a display apparatus according to the invention.

FIG. 8B is an exploded perspective view of an exemplary embodiment of an optical member of the display apparatus shown in FIG. 8A.

FIG. 9A is a flow chart of an exemplary embodiment of a manufacturing method of a backlight unit according to the invention.

FIG. 9B is a flow chart of an exemplary embodiment of a manufacturing method for forming a sacrifice pattern on a light guide in the method shown in FIG. 9A.

FIG. 9C is a flow chart of an exemplary embodiment of a manufacturing method for forming a cavity by removing a sacrifice pattern shown the method in FIG. 9A.

FIG. 9D is a flow chart of an exemplary embodiment of a manufacturing method for disposing a second insulation layer on a first insulation layer shown in the method of FIG. 9A.

FIG. 10A to 10I are cross-sectional views showing exemplary embodiments of processes in a manufacturing method of a backlight unit according to the invention.

FIG. 11A to 11E are cross-sectional views showing other exemplary embodiments of processes in a manufacturing method of a backlight unit according to the invention.

### DETAILED DESCRIPTION

The following description with reference to the accompanying drawings is provided to assist in a comprehensive understanding of various embodiments of the present disclosure as defined by the claims and their equivalents. Although the exemplary embodiments of the present disclosure have been described, it is understood that the present disclosure should not be limited to these exemplary embodiments but various changes and modifications can be made by one ordinary skilled in the art within the spirit and scope of the present disclosure as hereinafter claimed. Like numerals refer to like elements throughout the disclosure.

It will be understood that when an element such as a layer, film, region, or substrate is referred to as being related to another element such as being “on” another element, it can be directly on the other element or intervening elements may also be present. In contrast, when an element is referred to as being related to another element such as being “directly on,” “directly over,” or “directly above” another element or layer, there are no intervening elements or layers present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.”

“Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “below,” “beneath,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are not limited to a specific shape as shown, but may include a changed shape generated from a manufacturing process. Accordingly, it should be apparent to those skilled in the art that the following description of various embodiments of the present disclosure is provided for illustration purpose only and not for the purpose of limiting the present disclosure as defined by the appended claims and their equivalents.

Hereinafter, the invention will be explained in detail with reference to the accompanying drawings.

In a display apparatus including a display panel which generates and displays an image by using light and a backlight unit which generates the light, an optical sheet of the backlight unit provides the light to the display panel. The optical sheet generally includes a diffusion sheet, a prism sheet and/or a protection sheet. Here, the diffusion sheet serves to diffuse the light. The prism sheet is arranged on the diffusion sheet and condenses the light. The protection sheet which is disposed on the prism sheet protects the prism sheet.

A conventional optical sheet including a plurality of individual sheets may have a total thickness of about 0.5 millimeter (mm), thereby undesirably increasing an overall thickness of the display apparatus including such optical sheet in a backlight unit. Therefore, reducing an overall thickness of a display apparatus including an optical sheet in a backlight unit is desired.

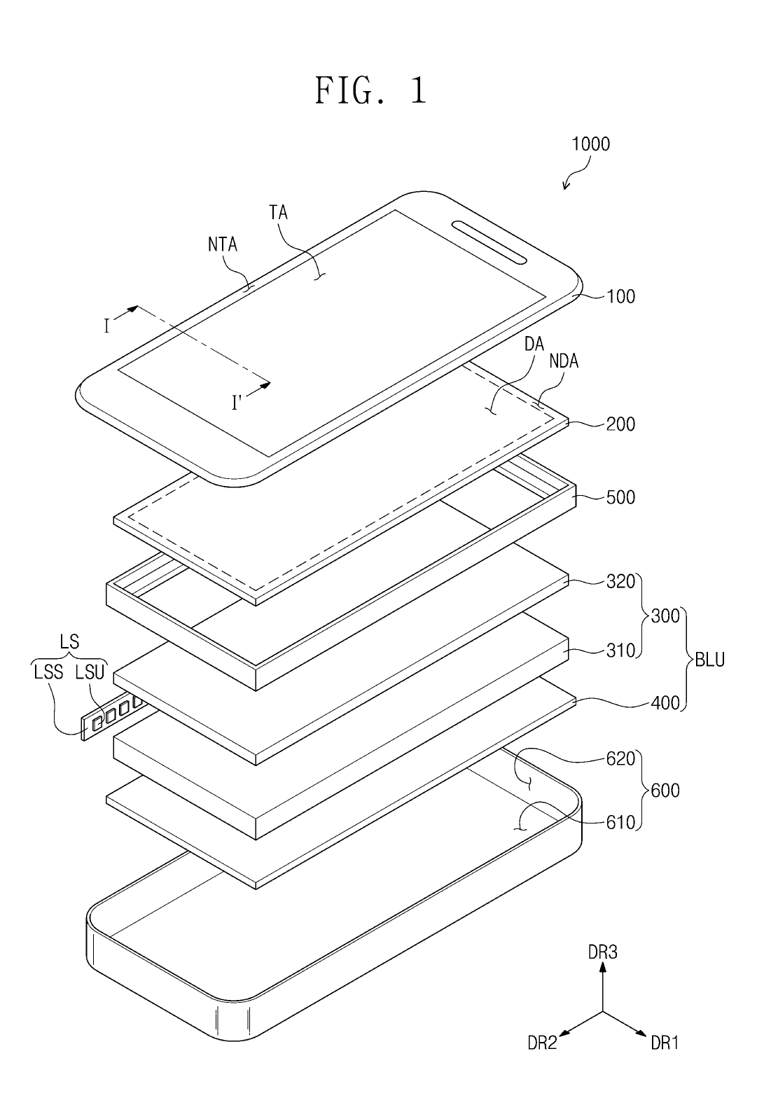

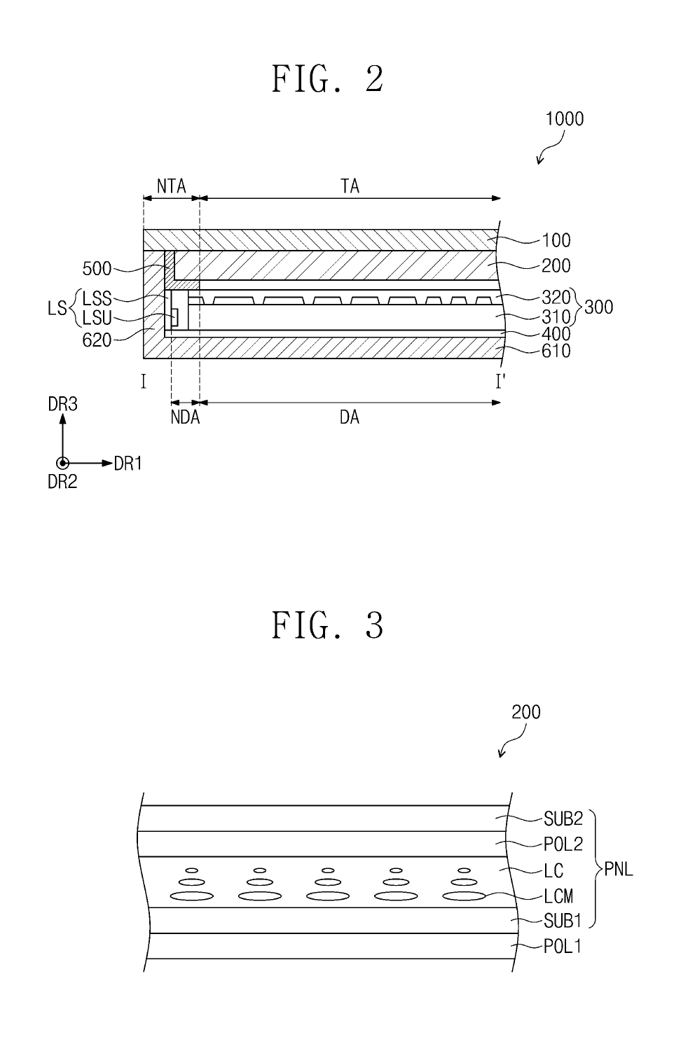

FIG. 1 is an exploded perspective view showing an exemplary embodiment of a display apparatus according to the invention and FIG. 2 is a cross-sectional view of the display apparatus taken along line I-I′ of FIG. 1.

Referring to FIG. 1 and FIG. 2, a display apparatus 1000 may have an overall rectangular shape having a relatively short side of which a length thereof extends in a first direction DR1 and a relatively long side of which a length thereof extends in a second direction DR2 crossing the first direction DR1. The display apparatus 1000 is disposed in a plane defined by the first and second directions DR1 and DR2. However, the shape of the display apparatus 1000 according to the invention is not limited thereto and may have various shapes. The display apparatus 1000 may include a window member 100, a backlight unit BLU and a receiving member 600.

For the convenience of explanation, a direction in which an image is displayed within the display apparatus 1000 is defined as an upward direction and a direction opposite thereto is defined as a downward direction. The upward direction and the downward direction are each parallel with a third direction DR3 which is orthogonal to both of the first direction DR1 and the second direction DR2. The third direction DR3 may be a reference direction which classifies a front surface and a rear surface of elements which will be described hereafter. The upward direction and the downward direction are relative, therefore each of these directions may be varied. Directions parallel to the third direction DR3 may also be considered a thickness direction of the display apparatus 1000 and elements thereof.

The window member 100 includes a light transmission area TA and a non-light transmission area NTA which is adjacent to the light transmission area TA. The light transmission area TA transmits an image provided from a display (panel) member 200 and the non-light transmission area NTA blocks the image to not be transmitted therefrom. The transmission area TA is placed at an area spaced apart from edges of the display apparatus 1000 such as at a center area of the display apparatus 1000 when viewed in a top plan view of the plane defined by the first direction DR1 and the second direction DR2. The non-transmission area NTA is adjacently disposed to the transmission area TA to surround the transmission area TA in a frame shape.

According to another embodiment, the window member 100 of the display apparatus 1000 may include only the light transmission area TA. That is, the non-light transmission area NTA may be omitted and the light transmission area TA may define an entire planar surface of the window member 100. In this case, an image may transmit throughout all the upper surface of the window member 100.

The window member 100 may include or be formed of glass, sapphire or plastic. The display member 200 is placed under the window member 100 in the thickness direction of the display apparatus 1000. The display member 200 generates an image and displays the image by using the light from the backlight unit BLU.

When viewed in the top plan view, the display member 200 provides a display area DA at which an image is displayed and a non-display area NDA at which an image is not displayed. The display area DA is provided spaced apart from edges of the display member 200 such as at the center area of the display member 200 and is overlapped with the transmission area TA of the window member 100. In the top plan view, the non-display area NDA is provided to surround the display area DA and to be overlapped with the non-light transmission area NTA of the window member 100. Hereinafter, the display member 200 will be described in detail with reference FIG. 3.

A backlight unit BLU is provided under the display member 200 and provides a light to the display member 200. According to one embodiment, the backlight unit BLU may be an edge type backlight unit. The backlight unit BLU includes a light source LS, an optical member 300 and a reflective member 400.

The light source LS is placed at a lateral face of the optical member 300 such as being adjacent thereto in the first direction DR1. However, a position of the light source LS is not limited, and may be placed adjacent to one or more lateral face of the optical member 300. The light source LS includes a light source unit LSU and a light source substrate LSS. The light source unit LSU may be provided in plurality on the light source substrate LSS. The light source units LSU generate a light, and provide the light to the optical member 300.

According to an exemplary embodiment of the present disclosure, a light emitting diode (“LED”) may be used as the light source unit LSU. However, a type of the light source unit LSU is not limited.

Also, there is no limit to the number of the light source units LSU within the light source LS. The light source unit LSU may be a point light source with one light emitting diode or a plurality of light emitting diodes. The light source unit LSU may be a line light source.

The light source units LSU may be mounted on the light source substrate LSS. The light source substrate LSS is provided to face a lateral face of the optical member such as to be adjacent thereto in the first direction DR1. The light source substrate LSS defines a length thereof which extends in the second direction DR2. A plurality of wirings may be provided on the light source substrate LSS to provide power to the light source units LSU.

The light source substrate LSS may include a light source controller (not shown) connected to the light source units LSU. The light source controller analyzes an image displayed by the display member 200 and generates a local dimming signal, and then controls luminance of the light generated from the light source units LSU in response to the local dimming signal.

According to another embodiment of this disclosure, the optical source controller (not shown) may be provided in the form of a circuit board on which a controller is separately mounted, but the position or location of the above described controllers is not specially limited thereto or thereby.

An optical member 300 is placed under the display member 200. The optical member 300 may include a light guide plate 310 and a light condensing member 320. The optical member 300 may be provided in the form of a combination type of the light guide plate 310 and the light condensing member 320 which are coupled to each other or a single unitary member operating as both the light guide plate 310 and the light condensing member 320.

The light guide plate 310 may be a plate shape. The light guide plate 310 changes the direction of the light incident thereto from the light source LS and allows the light to travel in an upward direction toward the display member 200. Although not shown in figures, a light diffusion pattern may be disposed or formed under the light guide plate 310.

The light source LS may be provided at a lateral face of the light guide plate 310 such as to be adjacent thereto in the first direction DR1. Among plural lateral faces of the light guide plate 310, a lateral face adjacent to the light source LS is defined as a light incident surface. Also, a lateral face opposite to the light incident surface among the lateral faces of the light guide plate 310 is defined as a light opposite surface. In an exemplary embodiment, for example, the light incident surface is provided at one lateral face, and the light opposite surface is provided at a lateral face of the light guide plate 310 opposite to the one lateral face. However, a position of the light source LS may be provided at any place adjacent to a lateral face among the lateral faces of the optical member 300, such as to not limit the position of the light source LS. A light emission or exit surface of the light guide plate 310 faces the light condensing member 320, and a rear surface of the light guide plate 310 is disposed opposite to the light emission surface thereof.

The light guide plate 310 may include a material having a relatively high light transmission in a visible (light) ray region. As an example, the light guide plate 310 may include or be made of, but not limited to, glass. According to another embodiment of this disclosure, the light guide plate 310 may include or be made of a transparent polymer resin, e.g., polycarbonate, polymethyl methacrylate (“PMMA”), etc.

The light condensing member 320 is placed between the light guide plate 310 and the display member 200. The light provided to the light condensing member 320 is condensed thereby and travels in the upward direction toward the display member 200 as condensed light.

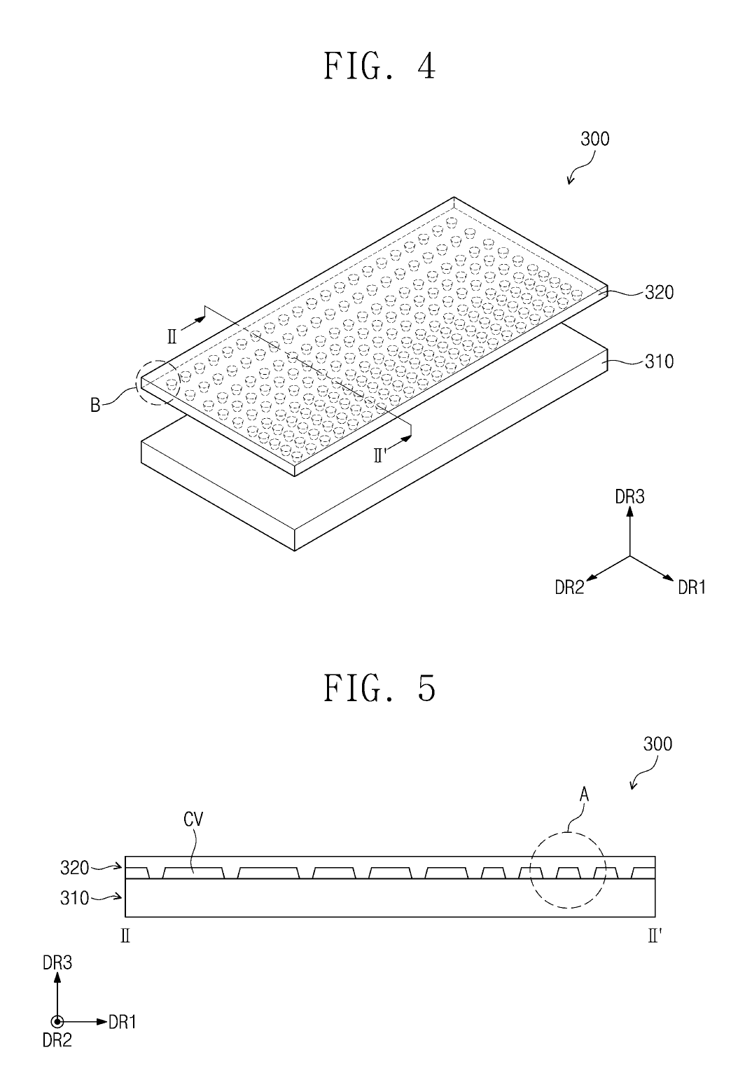

Hereinafter, the light guide plate 310 and the light condensing member 320 will be described in detail in FIG. 4 to FIG. 7. Although not shown in figures, the backlight unit BLU may further include at least one optical sheet (not shown). The optical sheet (not shown) is provided above or under the light condensing member 320. The optical sheet (not shown) may be a diffusion sheet and/or a protection sheet.

The display apparatus 1000 may further include a mold frame 500. The mold frame 500 is placed above the optical member 300. The mold frame 500 may be provided to correspond to an edge area of the upper portion in the optical member 300. The mold frame 500 may serve to fix the display member 200 within the display apparatus 1000. When the backlight unit BLU further includes an optical sheet (not shown), the mold frame 500 may fix the display member 200 together with the optical sheet.

The receiving member 600 is provided at the lowest end of the display apparatus 1000 and defines an outermost surface of the display apparatus 1000. The receiving member 600 receives the backlight unit BLU. The receiving member 600 may include a bottom portion 610 and a sidewall 620 which extends from an edge of the bottom portion 610. The sidewall 620 may be provided in plurality extending from the edge of the bottom portion 610 to be connected thereto. Plural sidewalls may collectively define a sidewall or sidewall member indicated by 620 in FIG. 1 and FIG. 2. The light source LS may be provided at an inner surface of a sidewall among the sidewalls 620. The receiving member 600 may include or be made of metal having relatively high strength.

FIG. 3 is an enlarged cross-sectional view showing the display member in FIG. 1.

Referring to FIG. 3, a display member 200 may include a first polarizing layer POL1 and a display panel PNL. The first polarizing layer POL1 is provided between the display panel PNL and the backlight unit BLU, and polarizes light components provided from the backlight unit BLU. The first polarizing layer POL1 may include a transmission axis (not shown) having a predetermined direction.

The display panel PNL is disposed on the first polarizing layer POL1. The display panel PNL generates an image and displays the image through the display area DA. The display panel PNL may be a non-emissive display panel. In an embodiment, for example, the display panel PNL may be a liquid crystal display panel.

The display panel PNL may further include a first (display) substrate SUB1, a second polarizing layer POL2, a second (display) substrate SUB2, and an optical transmission or display layer such as a liquid crystal layer LC.

The first substrate SUB1 is placed on the first polarizing layer POL1. The first substrate SUB1 may include or be made of material having relatively high light transmittance in order to pass the light provided from the backlight unit BLU. In an embodiment, for example, the first substrate SUB1 may be a transparent glass substrate, a transparent plastic substrate or a transparent glass.

Although not shown, the first substrate SUB1 includes a pixel area (not shown) at which the image is generated and displayed and a peripheral area (not shown) which is adjacent to the pixel area and at which the image is not displayed, when viewed in the top plan view.

In an embodiment, a pixel area may be provided in plural in the display apparatus 1000, and a peripheral area (not shown) is provided between the plural pixel areas (not shown). Each of the pixel areas (not shown) in the first substrate SUB1 may include a plurality of pixels (not shown) at which the image is generated and displayed. The pixels include a plurality of pixel electrodes (not shown) and a plurality of thin film transistors (not shown). In an embodiment, the thin film transistors are electrically connected to the pixels in a one-to-one correspondence. The thin film transistors are connected to the pixel electrodes, respectively, to be able to switch a driving signal applied to the corresponding each pixel electrode to generate and display the image.

The second substrate SUB2 may be placed to face above the first substrate SUB1 in a direction in which the image is displayed. The liquid crystal layer LC is interposed between the first substrate SUB1 and the second substrate SUB2. The liquid crystal layer LC includes liquid crystal molecule LCM arranged in plurality in a predetermined direction.

The second substrate SUB2 may include a common electrode (not shown). The pixel electrodes and the common electrode in cooperation generate an electric field to control arrangement of liquid crystal molecules LCM. The display member 200 operates the liquid crystal molecules LCM to display an image upwardly in the third direction DR3.

Although not shown in figures, the display member 200 may include a driving chip providing a driving signal, a tape carrier package (“TCP”) on which the driving chip is mounted, and a printed circuit board (“PCB”) electrically connected to the display member 200 by the tape carrier package.

The second polarizing layer POL2 may be disposed between the liquid crystal layer LC and the second substrate SUB2. However, the position of the second polarizing layer POL2 is not limited thereto. In an alternative embodiment, the second polarizing layer POL2 may be disposed on the second substrate SUB2 on a side thereof opposite to the liquid crystal layer LC.

The second polarizing layer POL2 may have an absorption axis (not shown) having a predetermined axis direction. When the display apparatus 1000 displays an image, the second polarizing layer POL2 transmits the light polarized at the first polarizing layer POL1. When the display apparatus 1000 does not display an image, the second polarizing layer POL2 absorbs the light polarized at the first polarizing layer POL1.

According to an arrangement of liquid crystal molecules LCM, an angle between the transmission axis of the first polarizing layer POL1 and absorption axis of the second polarizing layer POL2 may be determined. In an embodiment, for example, a transmission axis of the first polarizing layer POL1 is substantially vertical (e.g., perpendicular) to the absorption axis of the second polarizing layer POL2, when viewed in the plan view.

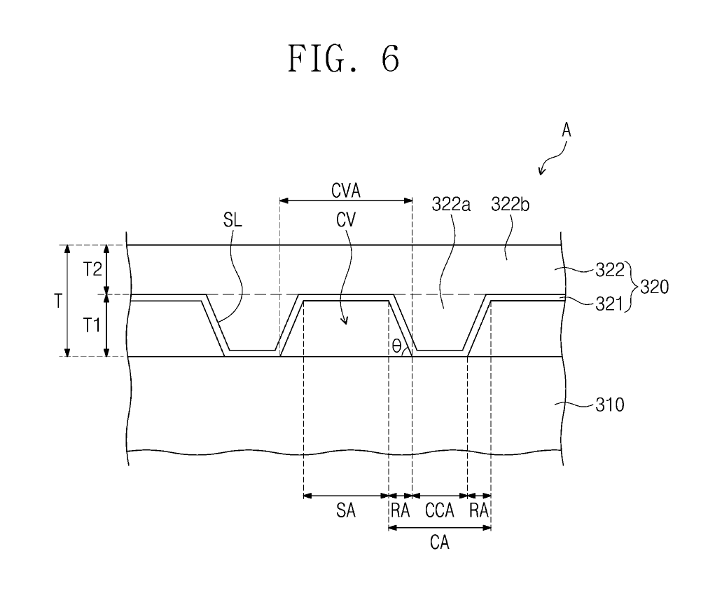

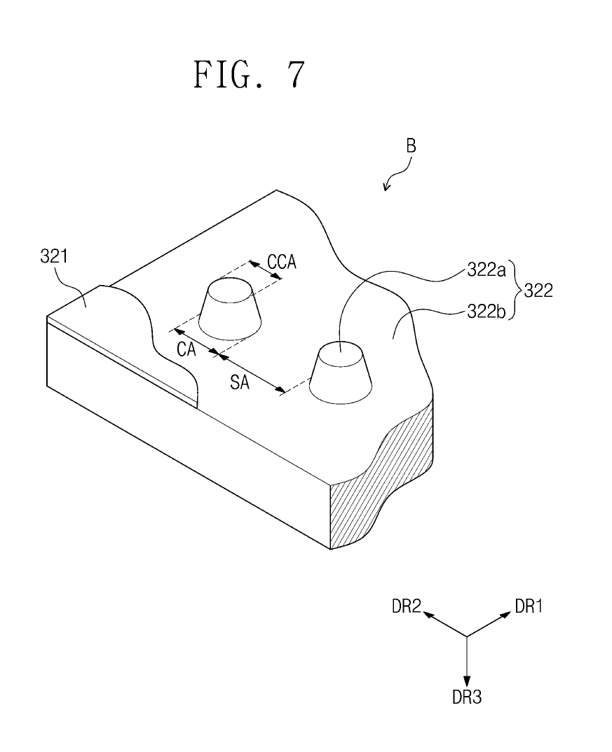

FIG. 4 is an exploded perspective view of an exemplary embodiment of an optical member, FIG. 5 is an enlarged cross-sectional view of the optical member taken along line II-II′ of FIG. 4, FIG. 6 is an enlarged cross-sectional view of an area A of the optical member of FIG. 5 and FIG. 7 is an exploded rear view of area B of an exemplary embodiment of a light condensing member shown in FIG. 4.

Referring to FIG. 4 to FIG. 7, an optical member 300 according to an exemplary embodiment of the present disclosure may have a combined shape in which the light guide plate 310 is coupled with a light condensing member 320.

In detail, a contact area CCA provided in plurality and a cavity area CVA are provided at an upper (emission) surface of the light guide plate 310. The cavity area CVA may collectively surround the contact areas CCA. Portions of the cavity area CVA may be alternated with the contact areas CCA in the first direction DR1. According to an exemplary embodiment of the present disclosure, in a top plan view, the contact areas CCA may each have a discrete shape such as a circular shape. The cavity area CVA may collectively surround the contact areas CCA in the top plan view. In detail, the cavity area CVA may collectively include a ring area RA provided in plurality and a surrounding area SA when viewed in the top plan view. The surrounding area SA is an entire area of a surface of the light guide plate 310 except for the ring areas RA. In the top plan view, the ring areas RA are a ring shape which may respectively surround the contact areas.

According to an exemplary embodiment of the present disclosure, the light guide plate 310 may have a first refractive index n1. In an embodiment, for example, when the light guide plate 310 is made of glass material, the first refractive index n1 is between about 1.2 and about 1.7.

A light condensing member 320 may include a first insulation layer 321 and a second insulation layer 322. The first insulation layer 321 is an all-in-on type when viewed in a plan view. That is, the first insulation layer 321 is a single, unitary member and is commonly disposed at the contact areas CCA and the surrounding area SA. A refractive index of the first insulation layer 321 is equal to or greater than that of the light guide plate 310. The first insulation layer 321 has a second refractive index n2 which is equal to or greater than the first refractive index n1. In an embodiment, for example, the second refractive index n2 may be between about 1.5 and about 1.8. According to another exemplary embodiment of the present disclosure, the first insulation layer 321 may include or be a silicon nitride SiNx material layer.

A portion of the first insulation layer 321 is disposed or formed to be spaced apart from the upper surface of the light guide plate 310, and another portion, such as a remaining portion thereof, is disposed or formed to contact the upper surface of the light guide plate 310. In detail, the first insulation layer 321 may be spaced apart from the upper surface of the light guide plate 310 at the cavity area CVA thereof and may contact the upper surface of the light guide plate 310 at the contact area CCA thereof. A cavity CV may be formed by the portions of the first insulation layer 321 separated from a surface of the light guide plate 310.

A bottom surface of the cavity CV is defined at the surface of the light guide plate 310 contacted by the first insulation layer 321. A size or planar area of the bottom surface of the cavity CV may be larger than that of an upper surface of the cavity CV at the second insulation layer 322. In cross-section, a lateral face of the cavity CV may include a slant surface SL. The cavity CV may be a trapezoid shape in cross section.

The cavity CV includes the bottom surface and the top surface described above. The size or planar area of the bottom surface of the cavity CV is defined by and equal to that of the cavity area CVA. The size of the top surface of the cavity CV is equal to that of the surrounding (peripheral) area SA. The lateral face of the cavity CV is overlapped with the ring area RA. While dimensions of the above-described elements are shown in a plane defined by the first and third directions DR1 and DR3 in FIG. 6, such dimensions may also be defined in a plane defined by the second and third directions DR2 and DR3, but the invention is not limited thereto.

In an exemplary embodiment, a slant angle θ between the slant surface SL and the upper surface of the light guide plate 310 may be between about 55 degrees (°) and about 65°. As an exemplary embodiment, a slant angle θ of the slant surface SL relative to the upper surface of the light guide plate 310 may be about 60°.

A refractive index of the cavity CV is less than the refractive index of the light guide plate 310. That is, the cavity CV has a third refractive index n3 less than the first refractive index n1 of the light guide plate 310. For example, when the cavity is formed with an air gap, the third refractive index n3 may be 1.0.

The second insulation layer 322 is disposed on the first insulation layer 321. The refractive index of the second insulation layer 322 is equal to the refractive index of the light guide plate 310. That is, the second insulation layer 322 may have the first refractive index n1. In an embodiment, for example, the second insulation layer 322 may include an organic material. Accordingly, the light emitted from the light guide plate 310 may be provided to the second insulation layer 322 via the first insulation layer 321, with or without passing through the cavity CV. The light provided to the second insulation layer 322 is reflected by the slant surface SL of the first insulation layer 321 and then is transmitted through the second insulation layer 322 to be condensed in the upward direction toward the display member 200.

The second insulation layer 322 may be a single, unitary member. The second insulation layer 322 may include or define a pattern portion 322a and a supporter 322b. The pattern portion 322a may be provided in plurality. As shown in FIG. 6, the pattern portions 322a are disposed in a same plane of the cavity CV. Each of pattern portions 322a may have a trapezoid shape where a size or planar area of top surface is larger than that of the bottom surface. Each bottom surface of the pattern portions 322a is overlapped with a contact area CCA of the light guide plate 310 and each top surface of the pattern portions 322a is overlapped with a contact area CCA together with a ring area RA which surrounds the contact area CCA. For convenience of explanation, the contact area CCA and the surrounding area SA of the light guide plate 310 are indicated relative to the portions of the second insulation layer 322 in FIG. 7.

Each of the contact areas CCA has a uniform width dimension in the first direction DR1. In an embodiment, for example, each of contact areas CCA may have a width dimension between 3 nanometers (nm) and 6 nm in the first direction DR1. The width dimension of a contact area CCA may be defined by a maximum dimension in the first direction DR1 (or the second direction DR2) of portions of the light condensing member 320 and the surface of the light guide plate 310 in contact with each other at a single contact area CCA.

Referring to FIG. 6, the light condensing member 320 may include a first thickness T1. The first thickness T1 includes the pattern portions 322a together with the first insulation layer 321 at the contact area CCA. The first thickness T1 may be a maximum sum of thicknesses of the pattern portions 322a and the first insulation layer 321 at the contact area CCA.

A supporter 322b may be a plane shape. The supporter 322b may be provided above the first insulation layer 321 to completely cover the light guide plate 310. In detail, the supporter 322b commonly covers the pattern portions 322a in a center area CA which includes a contact area CCA and ring area RA. The center area CA may be provided in plurality and the supporter 322b may be common to each of the center areas CA as shown in FIG. 6 and FIG. 7. In addition, the supporter 322b also covers the top surface of the first insulation layer 321 in the surrounding (peripheral) area SA. The surrounding area SA is an entire area of a surface of the light guide plate 310 except for the ring areas RA

Referring to FIG. 6, the light condensing member 320 has a second thickness T2. The second thickness T2 may be a maximum dimension of the supporter 322b.

A total thickness T of the light condensing member 320 includes both the first and second insulation layers 321 and 322, and is a maximum thickness including both the first and second insulation layers 321 and 322.

The first thickness T1 is equal to or larger than the second thickness T2. That is, the thickness T1 of the pattern portions 322a with the first insulation layer 321 may be half or more of the total thickness T of the light condensing member 320. In an embodiment, for example, total thickness T of the light condensing member 320 may be between 1 micrometer (um) and 10 micrometers (um).

According to an exemplary embodiment of the present disclosure, a light provided from the light guide plate 310 is transferred to the pattern portions 322a of the light condensing member 320. The light transferred to the pattern portions 322a is reflected by the slant surface SL and provided to the display member 200 in the upward (image display) direction.

Referring to FIG. 1, FIG. 2, FIG. 4 and FIG. 5, a light incident (lateral) surface of the light guide plate 310 is disposed adjacent to the light source LS. In an exemplary embodiment of the present disclosure, as the distance from the light incident surface increases (first direction DR1), a width of the cavity CV in the first direction DR1 may decrease. Thus, as the distance from the light incident surface of the light guide plate 310 is gradually increased, a density of the pattern portions 322a per a reference unit area may increase. That is, as the distance from the light incident surface is increased, a distance interval in the first direction DR1 between adjacent contact areas CCA may decrease.

Different from the above embodiments, such as in a conventional optical member, when a distance interval between the contact areas CCA is uniformly maintained at the top surface of the light guide plate 310, the efficiency of the light condensing may gradually decrease from the light incident surface to the light opposite surface. That is, brightness uniformity may be deteriorated. However, according to one or more exemplary embodiment of the present disclosure, since a density of the pattern portions 322a is gradually increased along the direction to the light opposite surface from the light incident surface (e.g., the first direction DR1), a deterioration or reduction of the brightness uniformity may be reduced or effectively prevented as an improvement over a conventional optical member.

In addition, according to one or more exemplary embodiment of the present disclosure, the light condensing member 320 condenses the light from the light guide plate 310 and provides the light in the upward direction toward the display member 200 such that a prism sheet used a conventional backlight unit may be omitted. Accordingly, since one or more exemplary embodiment of the present disclosure omits a prism sheet, an overall thickness of the display apparatus excluding such prism sheet may be reduced.

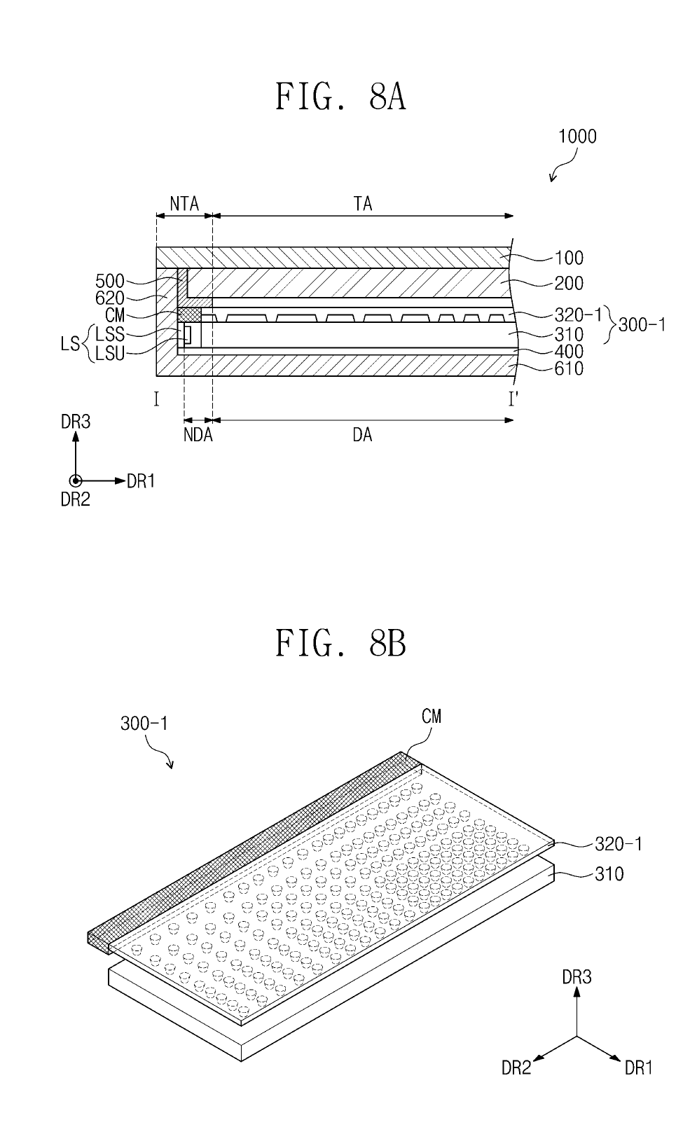

FIG. 8A is an enlarged cross-sectional view showing another exemplary embodiment of a display apparatus according to the invention, and FIG. 8B is an exploded perspective view of an optical member of the display apparatus shown in FIG. 8A.

In FIGS. 8A and 8B, the same reference numerals denote the same elements, and thus repeated descriptions of the same elements will be omitted.

Referring to FIG. 8A and FIG. 8B, the optical member 300-1 further includes a light blocking member CM. The light blocking member CM is provided at an end of the light condensing member 320-1 in the first direction DR1. The light blocking member CM is provided at the upper portion of the light source LS. In detail, when the light source LS defines a length thereof which extends along the second direction DR2, a length of the light blocking member CM may be extended along the second direction DR2 corresponding to the shape of the light source LS.

The light blocking member CM blocks a light which is not provided to the light guide plate 310 and is instead directly provided to the light condensing member 320-1, among lights from the light source LS. The light blocking member CM may include a material which absorbs the light to reflect the light back towards the light guide plate 310. Accordingly, according to one embodiment, the brightness uniformity may be more improved.

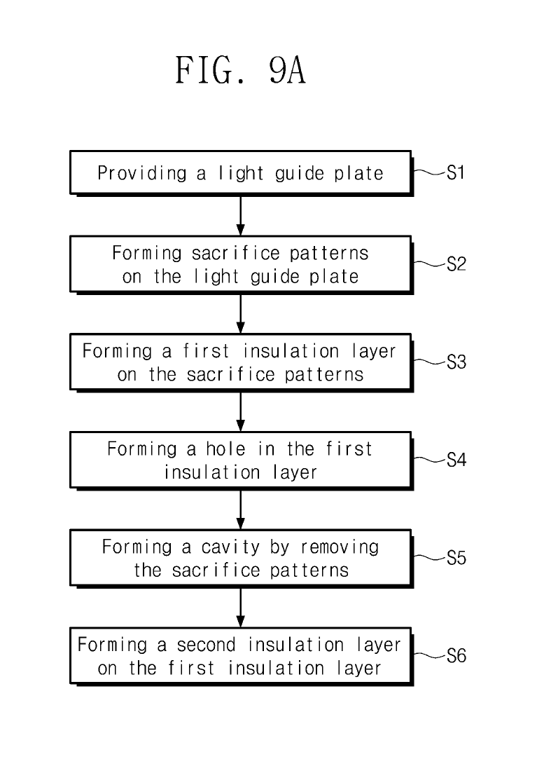

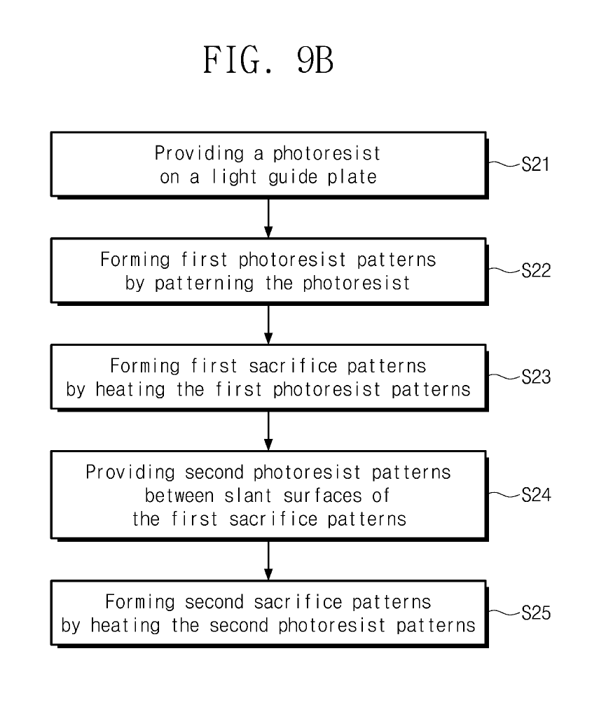

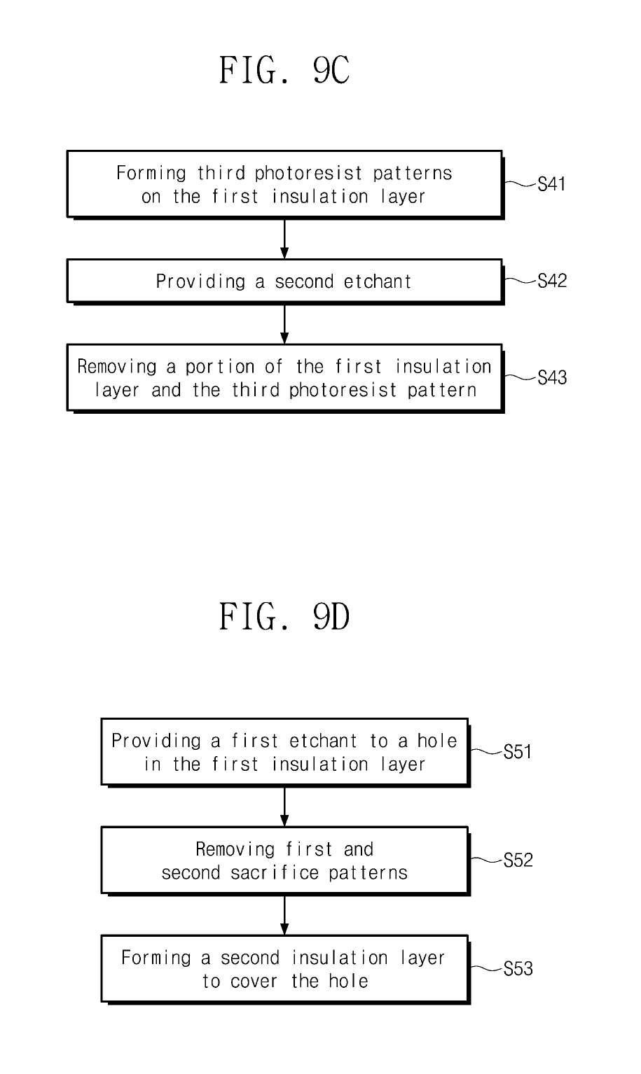

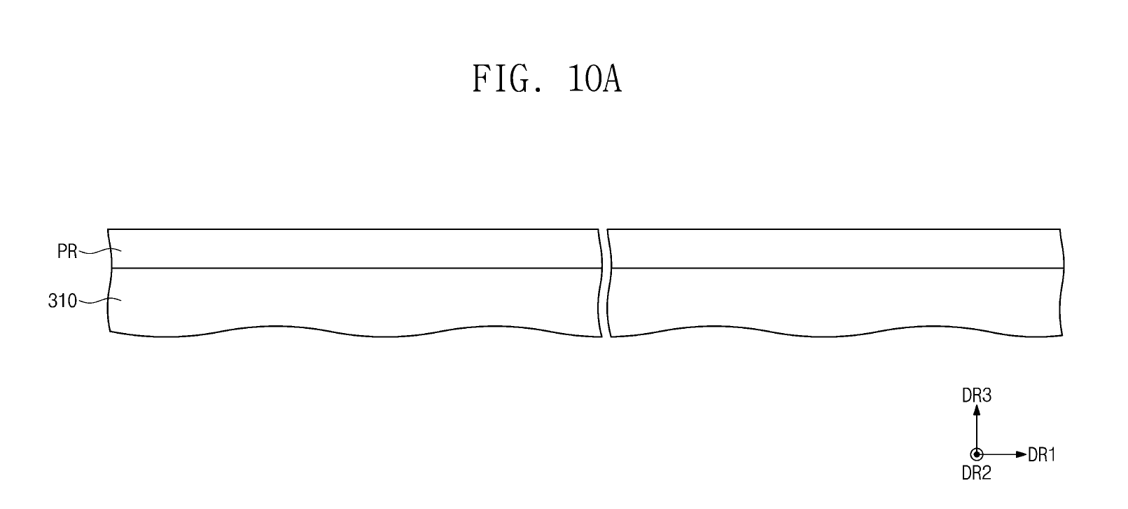

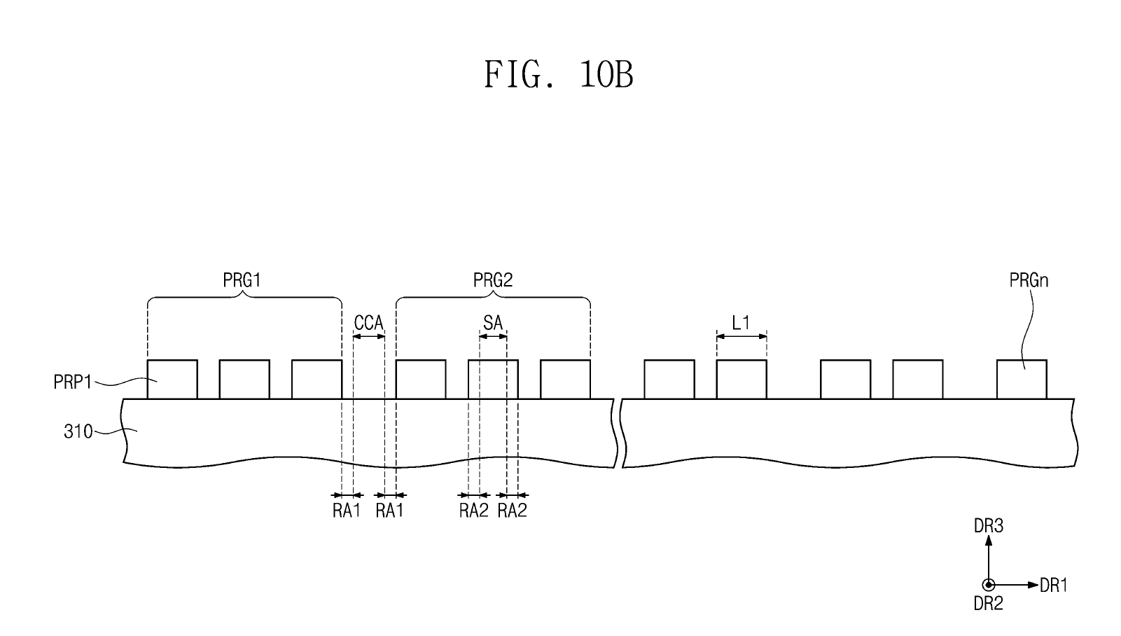

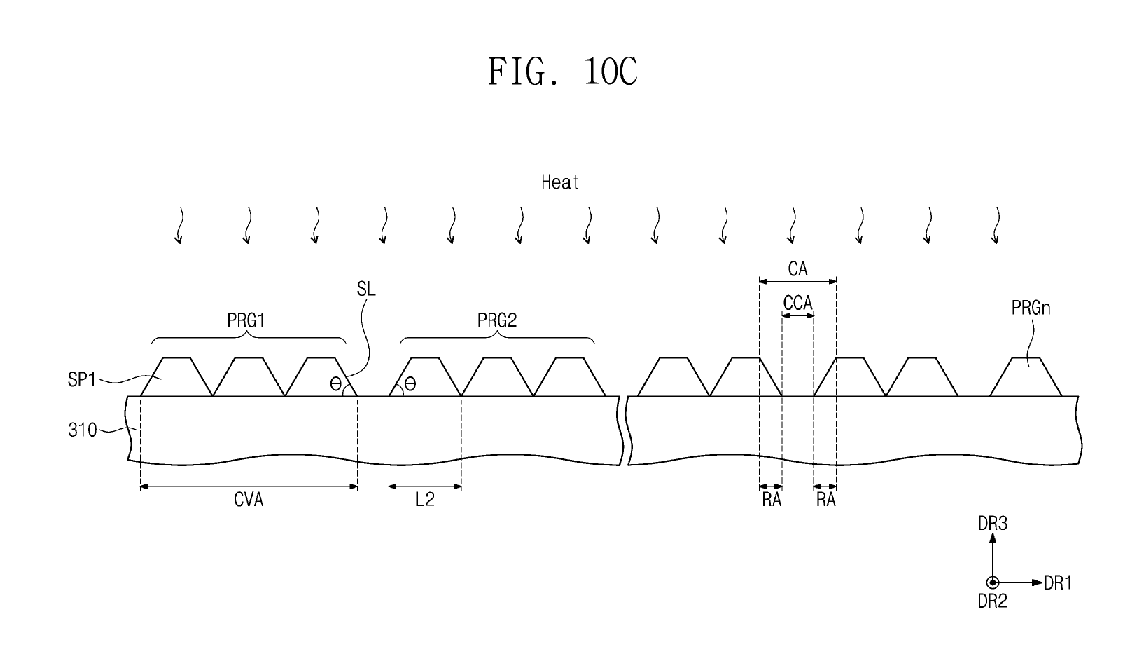

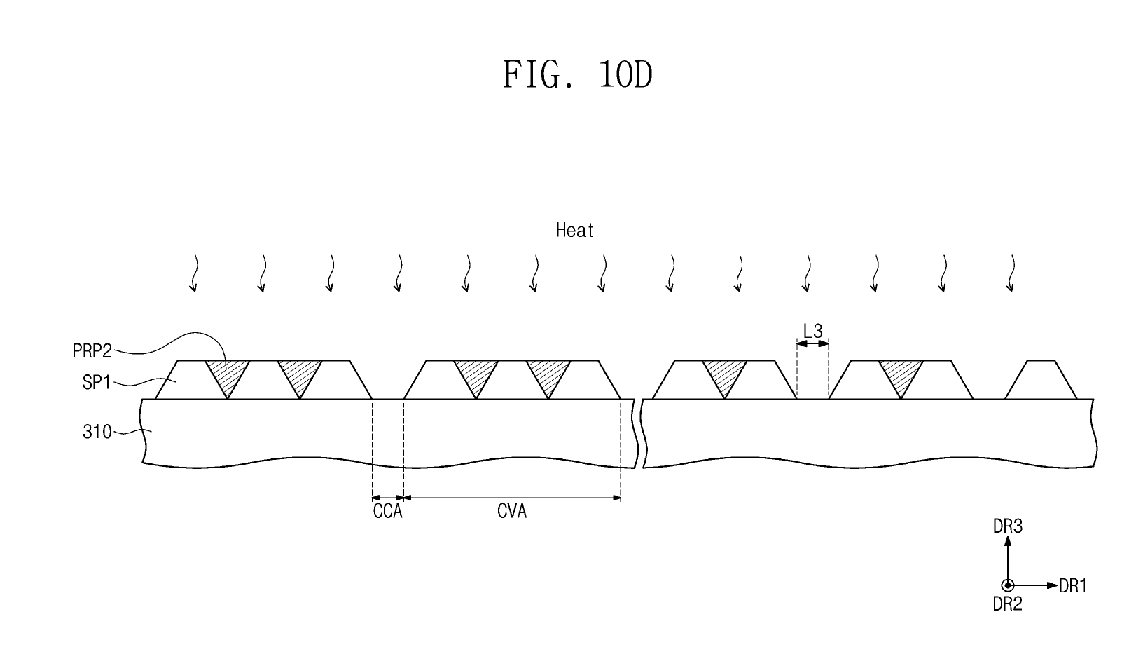

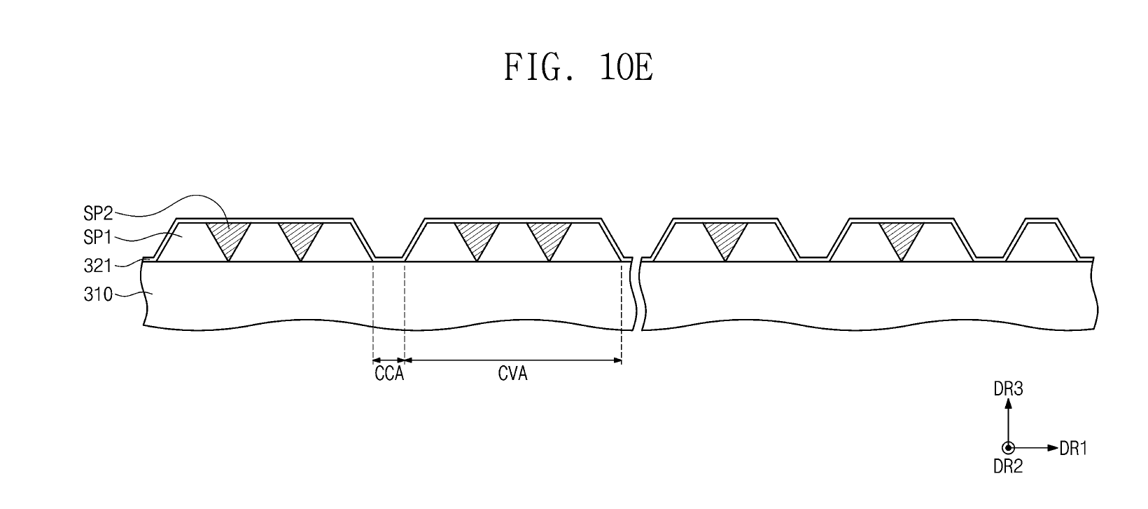

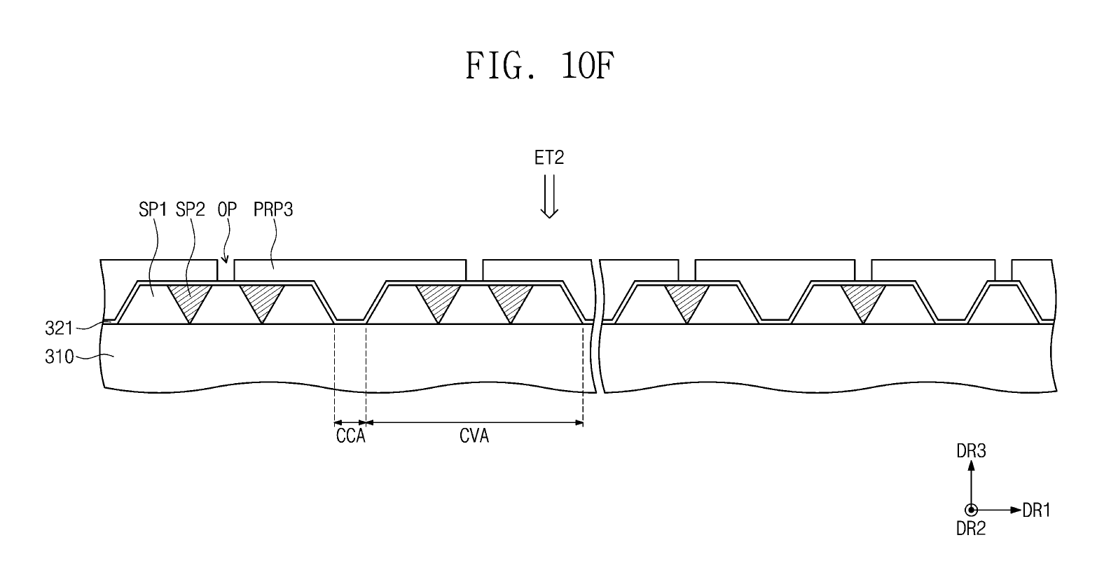

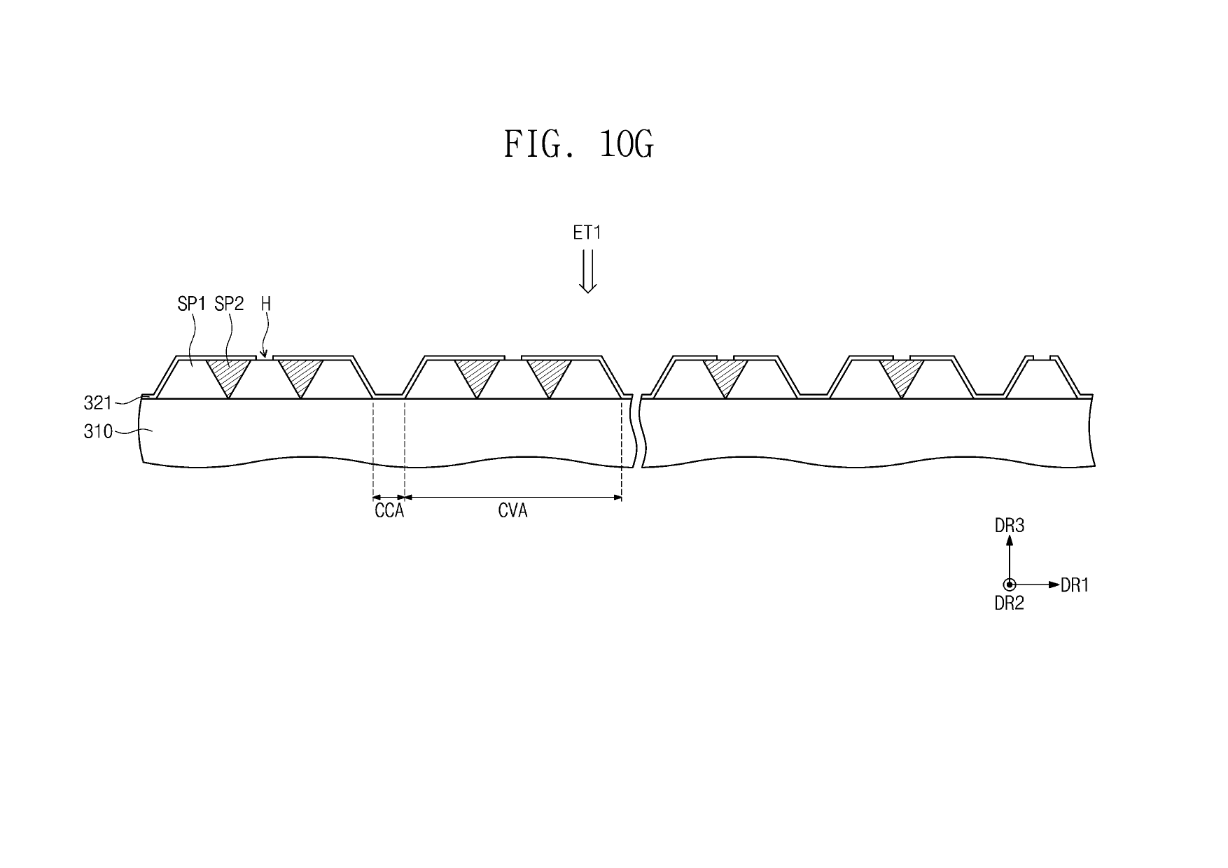

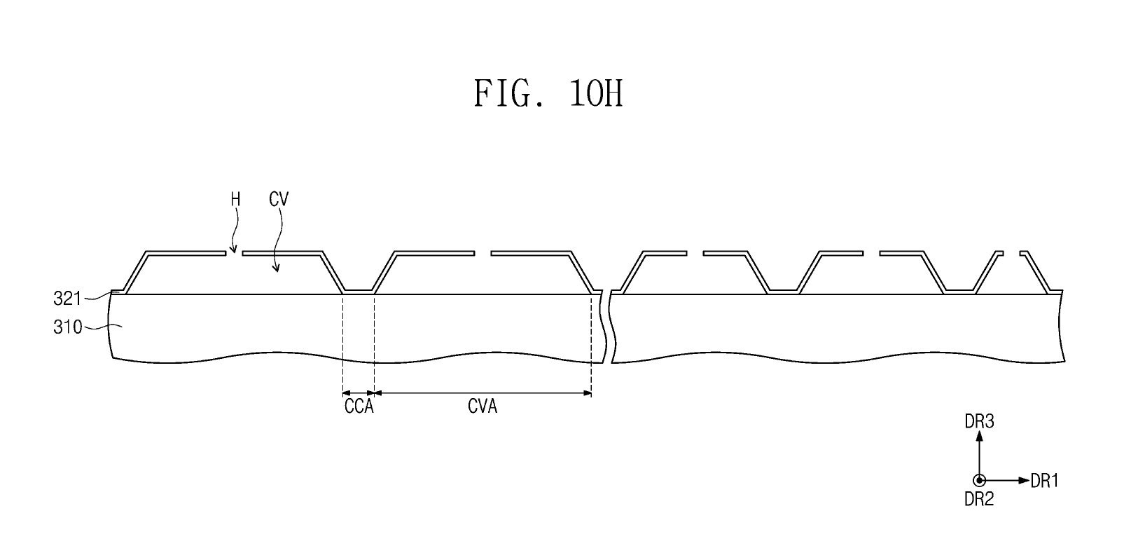

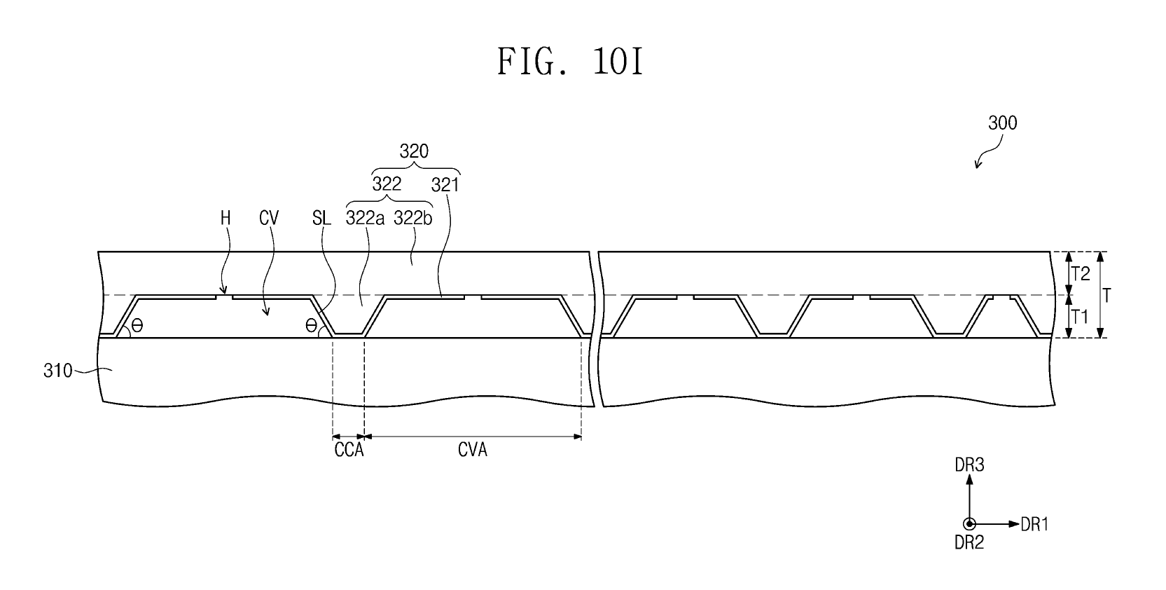

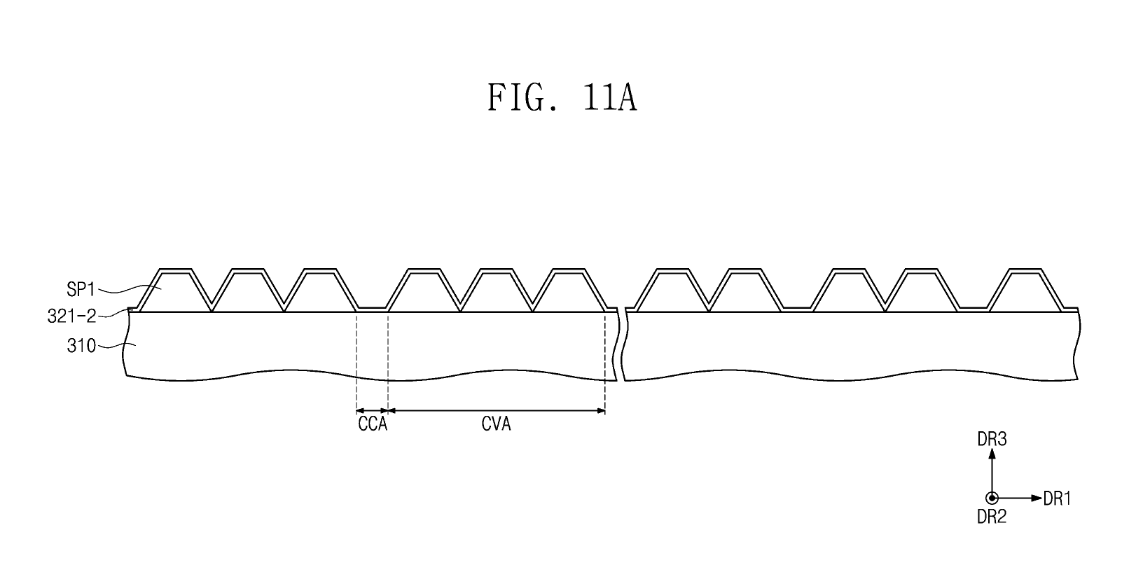

FIG. 9A to FIG. 9D are respectively flow charts for processes in an exemplary embodiment of a manufacturing method of the backlight unit according to the invention, and FIG. 10A to FIG. 10I are cross-sectional views showing manufacturing processes within the method of manufacturing the backlight unit of FIG. 9A to FIG. 9D. Referring to FIG. 9A to FIG. 10I, a manufacturing method of an optical member of a backlight unit used in a display apparatus according to the invention will be described. When explaining the FIG. 9A to FIG. 10I, the same reference numerals denote the same elements in previously described embodiments, and thus the detailed descriptions of the same elements will be omitted.

As shown in FIG. 9A, FIG. 9B and FIG. 10A, a light guide plate 310 is provided (S1). The light guide plate 310 may include a relatively high light transmission material in the visible (light) ray region. According to an exemplary embodiment of the present disclosure, the light guide plate 310 may have a first refractive index n1. In an embodiment, for example, when the light guide plate 310 includes a glass material, the first refractive index n1 is between about 1.2 and about 1.7.

A photoresist (material layer) PR is disposed on the light guide plate 310 (S2, S21). The photoresist PR completely covers the top surface of the light guide plate 310. In the exemplary embodiment, the photoresist PR may be a positive type photo resist.

Referring to FIG. 9A, FIG. 9B and FIG. 10B, after the photoresist PR is disposed (S2, S21), a first photoresist pattern PRP1 is formed in plurality after patterning the photoresist PR (S2, S22). The first photoresist patterns PRP1 are disposed to overlap with the area of the light guide plate 310 except the contact areas CCA thereof. As a distance from a light incident surface of the light guide plate 310 is increased along the first direction DR1, the number of the first photoresist patterns PRP1 which are adjacently arranged between adjacent contact areas CCA is decreased.

That is, the first photoresist patterns PRP1 arranged between the adjacent contact areas CCA form pattern groups PRG1 to PRGn. Accordingly, as a distance from the light incident surface of the light guide plate 310 is increased along the first direction DR1, the number of the first photoresist patterns PRP1 within a respective patter group among the pattern groups PRG1 to PRGn may decrease.

A width of the first photoresist patterns PRP1 in the first direction DR1 is uniform for the first photoresist patterns PRP1 arranged in the first direction DR1. In an embodiment, for example, a width of an individual one of the first photoresist patterns PRP1 may have a first width L1. A width dimension of each of the contact areas CCA may be uniform for contact areas CCA arranged in the first direction DR1. In an embodiment, for example, in the first direction DR1, each width of the contact areas CCA may be between about 3 nm and about 6 nm.

As shown in FIG. 9A, FIG. 9B and FIG. 10C, a heat treatment process is performed on the first photoresist patterns PRP1. Through the heat treatment process, heat at a first temperature is applied to the first photoresist patterns PRP1. When the heat at the first temperature is applied to the first photoresist patterns PRP1, the first photoresist patterns PRP1 are melted or deformed to form a lateral face of the first photoresist patterns PRP1 as a slant surface SL. As the slant surface SL is formed in the first photoresist patterns PRP1, a first sacrifice pattern SP1 is formed in plurality from the first photoresist patterns PRP1 (S2, S23).

A slant angle θ formed between the slant surface SL and a top surface of the light guide plate 310 may be between about 55° and about 65°. In an embodiment, the slant angle θ of the slant surface SL may be about 60°. All slant angles θ of the first sacrifice pattern SP1 may be the same.

As the first sacrifice patterns SP1 are formed, bottom surfaces of the first sacrifice patterns SP1 which are arranged adjacent to each other within a pattern group among the pattern groups PRG1 to PRGn may connect to each other. A collection of all the bottom surfaces of the first sacrifice patterns SP1 coupled each other along the first direction DR1 within a single pattern group overlap a single cavity area CVA.

With the bottom surfaces of the first sacrifice patterns SP1 connected to each other within a pattern group, the top surface of the light guide plate 310 is not exposed within the pattern group. In contrast, since the bottom surfaces of the first sacrifice patterns SP1 of different pattern groups adjacent to each other are disconnected, the top surface of the light guide plate 310 is exposed between the adjacent pattern groups.

A heat treatment temperature or time may be controlled for the slant angle to have a specific target slant angle range. In an embodiment, for example, when the first temperature is between about 120 degrees Celsius (° C.) and about 150° C., a target slant angle θ may be between about 55° and about 65°.

A width L1 of the first photoresist patterns PRP1 may be adjusted for forming the slant surface of the first sacrifice patterns SP1 to have a specific target slant angle range. In an embodiment, for example, when the first width L1 of the first photoresist patterns PRP1 is about 7 um to about 14 um, the range of a target slant angle θ may be about 55° to about 65°.

The width L1 of the first photoresist patterns PRP1 may be adjusted in cooperation with the heat treatment temperature, for forming the slant surface of the first sacrifice patterns SP1 to be within a specific target slant angle range.

As shown in FIG. 9A, FIG. 9B, and FIG. 10D, a second photoresist pattern PRP2 is formed in plurality from a photoresist material layer (not shown), to be disposed between slant surfaces of adjacent first sacrifice patterns SP1 within a pattern group (S2, S24). The second photoresist patterns PRP2 may not be formed between slant surfaces of adjacent pattern groups. Adjacent pattern groups are spaced apart from each other by a distance L3 corresponding to an interval between adjacent cavities to be formed. The pattern groups PRG1 to PRGn include the first sacrifice patterns SP1 hardened by the heat treatment process (FIG. 10C). The second photoresist patterns PRP2 functions as a planarizing layer. That is, a top surface of the first sacrifice patterns SP1 and a top surface of the second photoresist patterns PRP2 are coplanar with each other.

A heat treatment process is performed on the second photoresist patterns PRP2 formed between the first sacrifice patterns SP1 (S2, S25) to form second sacrifice patterns SP2. Through the heat treatment process, heat at a second temperature is applied to the second photoresist patterns PRP2 formed between the first sacrifice patterns SP1. The second temperature is lower than or equal to the first temperature.

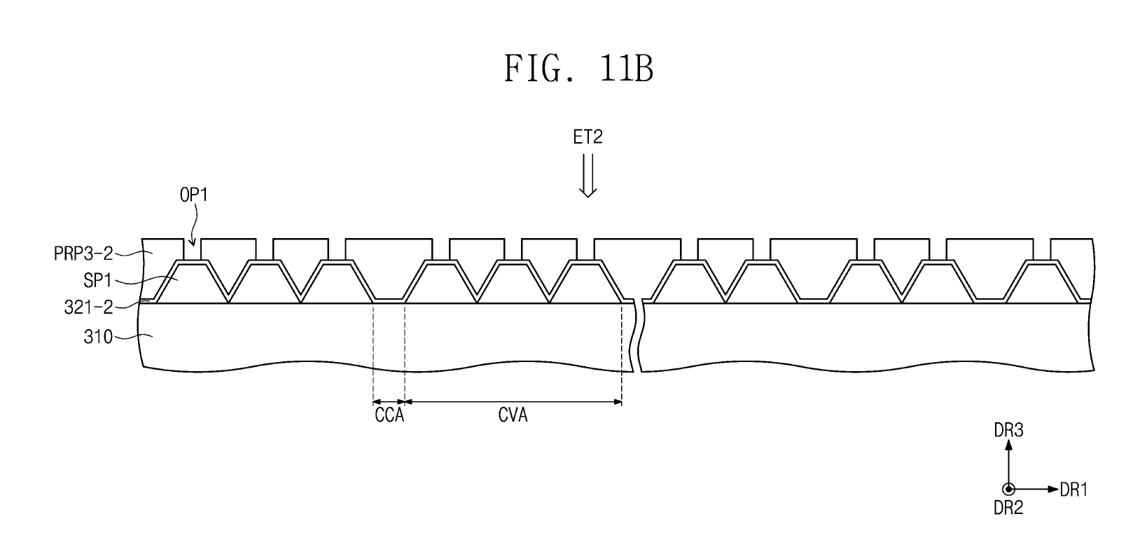

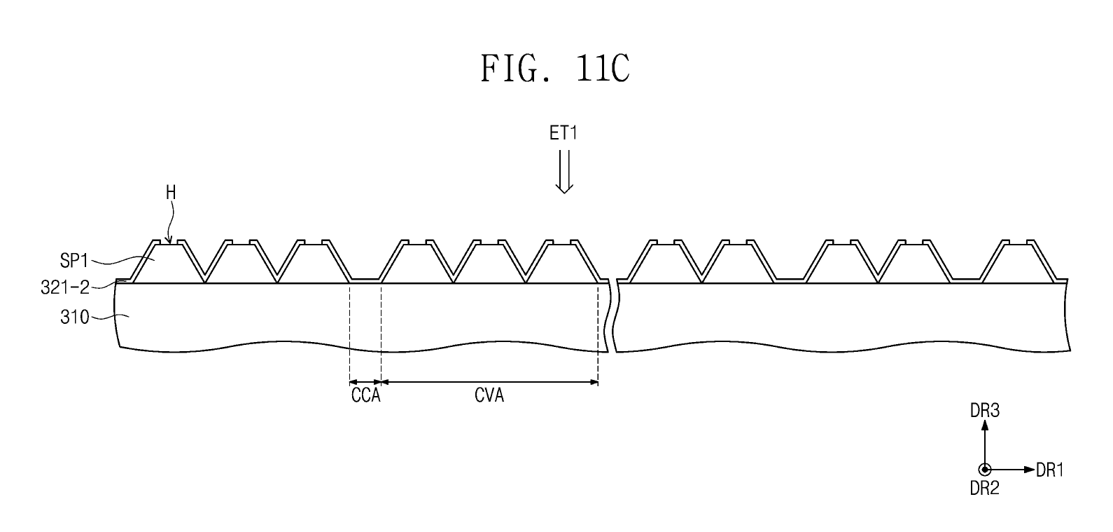

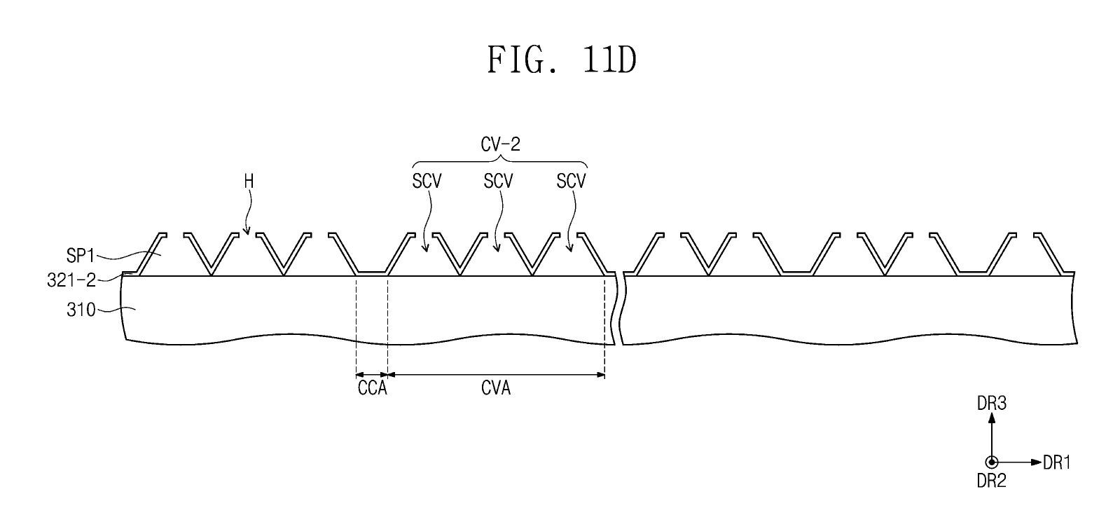

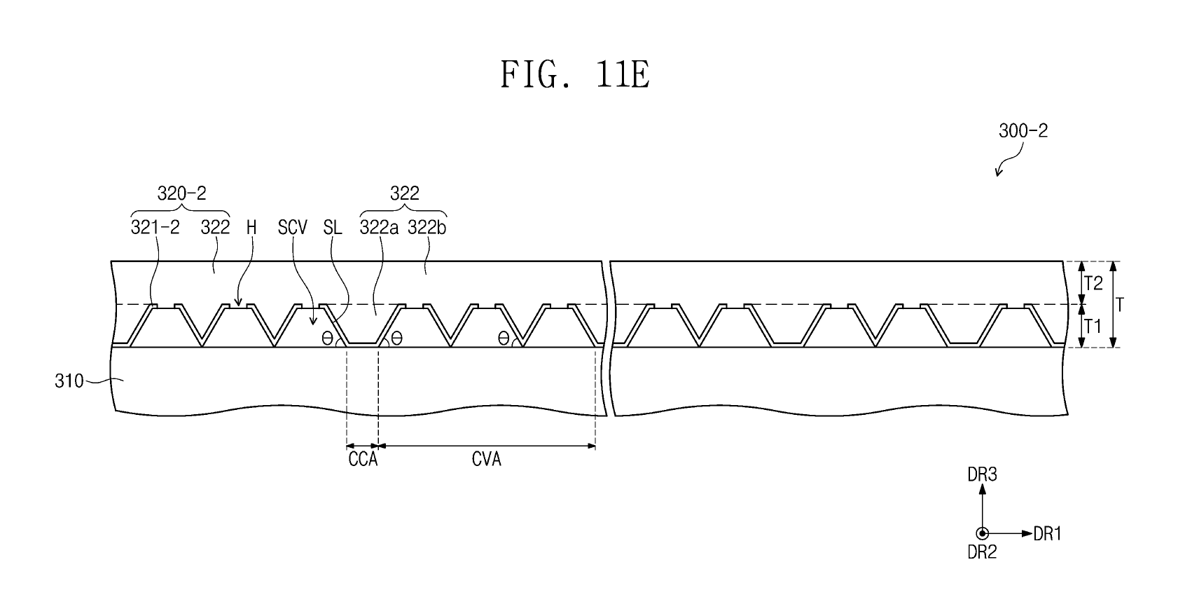

Forming processes (S2, S24, S24) for the second sacrifice patterns SP2 may be omitted. An exemplary embodiment of a manufacturing method in which forming processes (S2, S24, S24) for second sacrifice patterns SP2 are omitted will be hereinafter described with reference to FIG. 11A to FIG. 11E.

Referring to FIG. 9A and FIG. 10E, with the forming processes (S24, S24) for second sacrifice patterns SP2 performed, the first insulation layer 321 may be disposed on the first sacrifice patterns SP1, on the second sacrifice patterns SP2 and on an exposed portion of the top surface of the light guide plate 310 (S3). The configuration of the first insulation layer 321 will not be explained because it has already described above.

Referring to FIG. 9A, FIG. 9C and FIG. 10F, a third photoresist pattern PRP3 is formed in plurality on the first insulation layer 321 (S4, S41). The third photoresist pattern PRP3 is overlapped with a majority of a respective cavity area CVA except for a relatively small portion thereof. An open portion OP is formed in the third insulation pattern PRP3. That is, the open portion OP may overlap with the cavity area CVA. Through the open portion OP of the third photoresist pattern PRP3, a part of the insulation layer 321 may be exposed.

After forming the third photoresist patterns PRP3 to respectively include the open portions OP, an etching process is performed by applying a second etchant ET2 to the third photoresist patterns PRP3 and to the first insulation layer 321 through the open portions OP (S4, S42). The third photoresist patterns PRP3A and an exposed portion of the first insulation layer 321 are removed by the second etchant ET2 (S4, S43). As a portion of the first insulation layer 321 is removed, a hole H is formed in the first insulation layer 321 (S4).

Referring to FIG. 9A, FIG. 9D, FIG. 10G and FIG. 10H, a first etchant ET1 is provided to the hole H (S5, S51). The hole H exposes a portion of the sacrifice patterns SP1 and SP2. While FIG. 1OF and 10G show only the first sacrifice patterns SP1 exposed at the hole H, the invention is not limited thereto. In an embodiment, only the second sacrifice patterns SP2 may be exposed by the hole H or both sacrifice patterns SP1 and SP2 may be exposed by the hole H.

The first and second sacrifice patterns SP1 and SP2 may be removed by the first etchant ET1 applied thereto through the hole H (S5, S52). As the first and second sacrifice patterns SP1 and SP2 are removed, a cavity CV may be formed between the top surface of the light guide plate 310 and the first insulation layer 321 (S5). A width of the cavity CV in the first direction DR1 is the same as sum of widths of the bottom surfaces of the first sacrifice patterns SP1 within a single pattern group. The configuration of the cavity CV will not be explained because it has already described above.

Referring to FIG. 9A and FIG. 10I, the second insulation layer 322 is formed on the first insulation layer 321 (S6). The second insulation layer 322 on the first insulation layer 321 extends to cover the hole H through the first insulation layer 321. The second insulation layer 322 as the supporter 322b at the cavity area CVA extends to be disposed at the contact area CCA as both pattern portions 322a and the supporter 322b. The collective optical member 300 shown in FIG. 10I has the same configuration as that of FIG. 4 and FIG. 8B.

As described above, the width of the cavity CV in the first direction DR1 is proportional to the number of the first sacrifice patterns SP1 arranged within a single cavity area CVA. The overall width of the cavity CV may be adjusted by controlling the number of the first sacrifice patterns SP1 disposed within a single pattern group.

Different from the above embodiments, when the magnitude of conventional first sacrifice patterns in the first direction DR1 is the same as the width of the cavity to be formed, the width of the cavity CV may be controlled by adjusting the width of a respective first sacrifice pattern. In this case, a slant angle θ of the lateral face formed by the conventional first sacrifice patterns may not uniformly formed.

For example, as the first direction width of the conventional first sacrifice patterns increases, each slant angle θ of the first sacrifice patterns may decrease. When each slant angle θ of the conventional first sacrifice patterns is not uniform, lateral faces of the first insulation layer formed thereon may not be uniform. That is, the light condensing member formed by the conventional first sacrifice patterns may have reduced light condensing uniformity.

In one or more exemplary embodiment of the present disclosure, a width of the cavity CV in the first direction DR1 is controlled by arranging the plurality of first sacrifice patterns SP1 having the same width in the first direction, and thus the deterioration the light condensing uniformity may be reduced or effectively prevented. According to one or more exemplary embodiment of the present disclosure, an overall thickness of the backlight unit using such light condensing member is decreased since a prism sheet of a conventional backlight unit is omitted.

FIG. 11A to 11E are cross-sectional views showing other exemplary embodiments of processes in a manufacturing method of a backlight unit according to the invention. In FIG. 11A to FIG. 11E, the same reference numerals denote the same elements, and thus repeated descriptions of the same elements will be omitted.

In the manufacturing method as shown in FIG. 11A to FIG. 11E, forming the second photoresist patterns (S24) and forming the second sacrifice patterns (S25) shown in FIG. 9B are omitted.

Before performing the processes in FIG. 11A to FIG. 11E, processes in FIG. 10A to FIG. 10C are performed. FIG. 10A to FIG. 10C show the same manufacturing method of the backlight unit according to the present disclosure, and thus description will not be provided.

Referring to FIG. 11A, the first insulation layer 321-2 is disposed on the first sacrifice patterns SP1 formed on the light guide plate 310 and on an exposed portion of the top surface of the light guide plate 310 (S3). The configuration of the first insulation layer 321-2 is the same as the first insulation layer 321 described above, and thus detailed description will not be provided.

Referring to FIG. 11B, the third photoresist pattern PRP3-2 is disposed in plurality on the first insulation layer 321-2. The third photoresist patterns PRP3 are respectively partially overlapped with a cavity area CVA. A plurality of open portions OP1 is formed between adjacent third photoresist patterns PRP3. That is, each of the open portions OP1 may be partially overlapped with a cavity area CVA. In detail, each of the open portions OP1 is partially overlapped with a top surface of the first sacrifice patterns SP1 at a cavity area CVA. Through the open portion OP1, a portion of the first insulation layer 321-2 may be exposed.

After forming the third photoresist patterns PRP3-2, an etching process is performed by providing the second etchant ET2 to the third photoresist patterns PRP3-2 and to the first insulation layer 321-2 through the open portions OP1. The third photoresist patterns PRP3-2 and a portion of the first insulation layer 321-2 exposed through the open portion OP1 are removed. As a portion of the first insulation layer 321-2 is removed, a hole H is formed in the first insulation layer 321-2 (S4).

Referring to FIG. 11C and FIG. 11D, a first etchant ET1 is provided to the hole H. The hole H exposes a portion of the sacrifice patterns SP1. The first sacrifice patterns SP1 may be removed by the first etchant ET1 applied thereto through the hole H. As the first sacrifice patterns SP1 are removed, a cavity CV is formed between the top surface of the light guide plate 310 and the first insulation layer 321-2 (S5). In the first direction DR1, a width of the cavity CV is the same as the sum of widths of the first sacrifice patterns SP1 in a first direction DR1 which correspond to a single pattern group among pattern groups PRG1 to PRGn.

As shown in FIG. 11D, the cavity CV-2 may include a plurality of sub cavities SCV. In the first direction DR1, a bottom surface width of each of sub cavities SCV is the same as that of the first sacrifice pattern SP1. The cavity CV-2 corresponds to a single cavity area CVA of the light guide plate 310.

Although not shown in figures, according to another exemplary embodiment of the present disclosure, adjacent sub cavities SCV are partially overlapped each other. That is, the cavity may be integrally formed in a single, unitary cavity with the sub cavities SCV connected to or in communication with each other.

Referring to FIG. 11E, the second insulation layer 322 is disposed on the first insulation layer 321 (S6). The second insulation layer 322 as the supporter 322b at the sub cavities SCV extends to be disposed at the contact area CCA as both pattern portions 322a and the supporter 322b. The second insulation layer 322 as the supporter 322b also extends to be disposed between the sub cavities SCV within a single cavity CV-2. The second insulation layer 322 covers the holes H formed in the first insulation layer 321-2. The collective optical member 300-2 shown in FIG. 11E has the same configuration as that of FIG. 4 and FIG. 8B.

According to one or more exemplary embodiment of the present disclosure, a width of the overall cavity CV-2 in the first direction DR1 is controlled by arranging the plurality of first sacrifice patterns SP1 having the same width in the first direction DR1, and thus the deterioration of the light condensing uniformity may be reduced or effectively prevented.

In addition, according to one or more exemplary embodiment of the present disclosure, the light condensing member 320-2 condenses the light provided from the top surface of the light guide plate, a prism sheet of a conventional backlight unit is omitted. Accordingly, an overall thickness of a display apparatus in which the light condensing member 320-2 is used may be reduced.

While exemplary embodiments are described above, a person skilled in the art may understand that many modifications and variations may be made without departing from the spirit and scope of the invention defined in the following claims. While exemplary embodiments are described above, a person skilled in the art may understand that many modifications and variations may be made without departing from the spirit and scope of the invention defined in the following claims.

What is claimed is:

1. A method of manufacturing a backlight unit, the method comprising:
providing a light guide plate comprising a light emission surface, a light incident surface and a light opposite surface which faces the light incident surface in a first direction, the light emission surface comprising a plurality of contact areas and a cavity area which is between adjacent contact areas;
forming a plurality of first sacrifice patterns on the light emission surface of the light guide plate at the cavity area thereof, the plurality of first sacrifice patterns having a same width as each other in the first direction;
forming a first insulation layer on the plurality of first sacrifice patterns at the cavity area of the light guide plate, such first insulation layer extended to contact the light emission surface of the light guide plate at the contact areas;
removing the plurality of first sacrifice patterns to form a cavity between the light emission surface of the light guide plate and the first insulation layer, at the cavity area; and
with the cavity formed at the cavity area, forming a second insulation layer on the first insulation layer at the cavity area and at the contact areas,
wherein
the contact areas are arranged spaced apart from each other in the first direction, and
a number of the first sacrifice patterns at the cavity area between the adjacent contact areas decreases as a distance in the first direction from the light incident surface increases.

2. The method of manufacturing a backlight unit as recited in claim 1, wherein the forming the plurality of first sacrifice patterns comprises:
forming a photoresist on the light emission surface of the light guide plate;
forming a plurality of first photoresist patterns having a same width as each other in the first direction, by patterning the photoresist; and
heating the first photoresist patterns to respectively form the plurality of first sacrifice patterns having a lateral face at the contact areas, the lateral face to have a target slant angle,
wherein the target slant angle is defined as an angle between the lateral face of the first sacrifice patterns at the contact area and the light emission surface of the light guide plate.

3. The method of manufacturing a backlight unit as recited in claim 2, wherein the target slant angle is between about 55° and about 65°.

4. The method of manufacturing a backlight unit as recited in claim 2, wherein the forming the cavity comprises:
removing a portion of the first insulation layer at the cavity area between the adjacent contact areas, to form a hole at the cavity area which is between the adjacent contact areas; and
providing a first etchant to the hole to remove the plurality of first sacrifice patterns at the cavity area and form the cavity.

5. The method of manufacturing a backlight unit as recited in claim 4, wherein the forming the hole comprises:
forming a third photoresist pattern on the first insulation layer at the cavity area to expose the portion of the first insulation layer at the cavity area; and
removing the third photoresist pattern and the portion of the first insulation layer at the cavity area, by providing a second etchant to the portion of the first insulation layer exposed by the third photoresist pattern.

6. The method of manufacturing a backlight unit as recited in claim 2, further comprising:
with the plurality of first sacrifice patterns at the cavity area between the adjacent contact areas, forming a plurality of second photoresist patterns between lateral faces of the first sacrifice patterns within the cavity area; and
heating the second photoresist patterns between the lateral faces of the first sacrifice patterns within the cavity area, to form a plurality of second sacrifice patterns between the lateral faces of the first sacrifice patterns within the cavity area,
wherein the forming the first insulation layer disposes the first insulation layer on an upper surface of the first sacrifice patterns and on an upper surface of the second sacrifice patterns.

7. The method of manufacturing a backlight unit as recited in claim 6, wherein the forming the cavity comprises:
removing a portion of the first insulation layer at the cavity area between the adjacent contact areas, to form a hole at the cavity area between the adjacent contact areas; and
providing a first etchant to the hole to remove the plurality of first sacrifice patterns and the plurality of second sacrifice patterns at the cavity area and form the cavity.

8. The method of manufacturing a backlight unit as recited in claim 1, wherein
portions of the cavity area alternate with contact areas in the first direction, and
within a single portion of the cavity area, bottom surfaces of the first sacrifice patterns are connected to each other.

9. The method of manufacturing a backlight unit as recited in claim 1, wherein a refractive index of the light guide plate is greater than a refractive index of the cavity, equal to a refractive index of the second insulation layer, and lower than or equal to a refractive index of the first insulation layer.

10. The method of manufacturing a backlight unit as recited in claim 1, wherein the refractive index of the cavity is about 1.0.

11. The method of manufacturing a backlight unit as recited in claim 1, wherein each of the contact areas has a same width in the first direction.

12. A backlight unit comprising:
a light source which generates a light used by a display member to display an image;
a light guide plate comprising a light emission surface through which the light exits the light guide plate to the display member, a light incident surface through which the light enters the light guide plate from the light source, and a light opposite surface facing the light incident surface in the first direction; and
a light condensing member in contact with the light emission surface of the light guide plate to condense the light exiting from the light guide plate,
wherein
the light emission surface of the light guide plate defines a plurality of contact areas at which the light condensing member contacts the light guide plate, the contact areas arranged spaced apart from each other in the first direction, and
the light condensing member comprises:
a first insulation layer contacting the light emission surface of the light guide plate at the contact areas thereof, the first insulation layer spaced apart from the light emission surface of the light guide plate to define a cavity between adjacent contact areas; and
a second insulation layer disposed on the first insulation layer at the contact areas of the light guide plate and at the cavity,
wherein for the contact areas arranged spaced apart from each other in the first direction, a width between the adjacent contact areas decreases as a distance in the first direction from the light incident surface increases.

13. The backlight unit of claim 12, wherein the first insulation layer at a lateral side of the cavity forms an angle with the light emission surface of the light guide plate between about 55° and about 65°.

14. The backlight unit of claim 12, wherein a refractive index of the light guide plate is greater than a refractive index of the cavity, lower than or equal to a refractive index of the first insulation layer, and equal to a refractive index of the second insulation layer.

15. The backlight unit of claim 12, wherein in a thickness direction of the light condensing member, a height of the cavity is greater than or equal to half a total thickness of the light condensing member comprising the first and second insulation layers.

16. The backlight unit of claim 12, further comprising a light blocking member connected to a lateral face of the light condensing member, the lateral face being adjacent to the light source.

17. The backlight unit of claim 12, wherein each of the contact areas has a same width in the first direction.

18. A display apparatus comprising:
a display panel which displays an image with light; and
a back light unit which provides the light to the display panel,
wherein the backlight unit comprises:
a light source which generates the light; and
an optical member which guides the light from the light source to the display panel,
the optical member comprising:
a light guide plate comprising a light emission surface through which the light exits the light guide plate, and a light incident surface at which the light source is disposed; and
a light condensing member in contact with the light emission surface of the light guide plate to condense the light exiting from the light guide plate,
wherein
the light emission surface of the light guide plate defines a plurality of contact areas at which the light condensing member contacts the light guide plate, the contact areas arranged spaced apart from each in a direction away from the light incident surface of the light guide plate,
the light condensing member defines a plurality of cavities respectively between contact areas adjacent to each other, and
in the direction away from the light incident surface of the light guide plate, an interval between the adjacent contact areas decreases as a distance from the light incident surface increases.

19. The display apparatus of claim 18, wherein the light condensing member comprises:
a first insulation layer contacting the light emission surface of the light guide plate at the contact areas thereof, the first insulation layer spaced apart from the light emission surface to define the cavities therebetween, and
a second insulation layer disposed on the first insulation layer at the contact areas and at the cavities.

20. The display apparatus of claim 19, wherein the first insulation layer at a lateral side of a cavity forms an angle with the light emission surface of the light guide plate between about 55° and about 65°.
